(19) United States
(12) Patent Application Publication
(10) Pub. No.: US 2002/0142194 A1
(43) Pub. Date: Oct. 3, 2002

(54) Battery for an electronic device and an electronic device using the same

(75) Inventors: Soon-kyo Hong, Seoul (KR); Byoung-young Bae, Gyeonggi-do (KR); Bu-hyun Sung, Gyeonggi-do (KR); Young-min Cheong, Seoul (KR)

Correspondence Address: STAAS & HALSEY LLP, 700 11TH STREET, NW, SUITE 500, WASHINGTON, DC, 20001, US

(73) Assignee: SAMSUNG ELECTRONICS CO., LTD., Suwon-city (KR)

(21) Appl. No.: 09/996,764

(22) Filed: Nov. 30, 2001

(30) Foreign Application Priority Data
Mar. 27, 2001 (KR) 2001-16010

(51) Int. Cl. H01M 2/10; H01M 10/38

(52) U.S. Cl. 429/7; 429/123

(57) ABSTRACT

An electronic device includes a body and a battery to supply various components in the body with current. The battery includes a memory having a built-in main memory and a detachable auxiliary memory. The built-in memory and/or the auxiliary memory are, optionally, connected to another device. According to such configuration, the electronic device can be portable to easily store required information via the memory unit installed on the battery anytime and anywhere.

### CROSS-REFERENCE TO RELATED APPLICATIONS

This application claims the benefit of Korean Application No. 2001-16010, filed Mar. 27, 2001, in the Korean Industrial Property Office, the disclosure of which is incorporated herein by reference.

### BACKGROUND OF THE INVENTION

1. Field of the Invention

The present invention relates to a battery for an electronic device having a function of storing information, and an electronic device using the same.

2. Description of the Related Art

As info-communications areas develop, the use of portable electronic devices, such as portable phones, has become more widespread. Portable electronic devices have a variety of functions, from wireless Internet surfing to simple audio communication or communication of character based messages.

A portable phone, which is one form of electronic device such as that shown in FIG. 1, includes a body 10 having principal parts such as a controller (not shown) or a display and a battery 20, which is detachable from the body 10 to supply current to the principal parts in the body 10. Thus, the principal part such as the controller is supplied with current from the battery 20. In this way, the electronic device is able to operate so that various functions, such as communication, are carried out in the body 10.

However, as electronic devices are more widely used, the electronic devices such as the portable phone also require an information storage function to store desired information whenever it is needed. The information storage function is in addition to the general communication function. This is because almost all information is interchanged in a digital file form. Thus, a mechanism is required to rapidly and simply download and store such information anytime and anywhere, and to read the information whenever it is needed. In particular, portable electronic devices such as portable phones, which are carried by a user, are most suitable for such a mechanism.

A plan for additionally installing a large capacity storage medium in the body 10 was proposed. However, this plan increases the size and complexity of the body 10 in which many principal parts are built. Therefore, even people who do not desire a large capacity storage medium would have no choice but to carry bulky devices, which would generate complaints. Also, the electronic devices require an additional transceiving line between them to directly interchange information with each other if a storage medium is installed in the body 10, which is inconvenient to use. The transceiving line is required even where the electronic devices are of the same kind.

Accordingly, devices having a new configuration for rapidly and simply storing and interchanging information anytime and anywhere are required to make up for these disadvantages.

### SUMMARY OF THE INVENTION

To solve the above and other problems, it is an object of the present invention to provide a battery for an electronic device having a function of rapidly and simply storing and interchanging desired information, and an electronic device using the same.

Additional objects and advantages of the invention will be set forth in part in the description which follows and, in part, will be obvious from the description, or may be learned by practice of the invention.

Accordingly, to achieve the above and other objects, an electronic device according to an embodiment of the invention includes a body including a controller and a battery coupled to the body to supply current to the controller, wherein the battery includes a memory unit having a built-in main memory and a detachable auxiliary memory.

According to another embodiment of the present invention, a battery for an electronic device that is detachable from a body of the electronic device and which includes a memory unit having a built-in main memory and a detachable auxiliary memory.

### BRIEF DESCRIPTION OF THE DRAWINGS

The above and other object and advantages of the present invention will become more apparent and more readily appreciated by describing in detail embodiments thereof with reference to the accompanying drawings in which:

FIG. 1 shows a conventional electronic device;

FIG. 2 shows an electronic device and a battery used in the electronic device according to an embodiment of the present invention;

FIG. 3 is an exploded perspective view of the battery shown in FIG. 2;

FIGS. 4A through 5B show uses of a communication port built into the battery of FIG. 2 according to additional embodiments of the present invention; and

FIG. 6 show uses of a power output port built into the battery of FIG. 2 according to a further embodiment of the present invention.

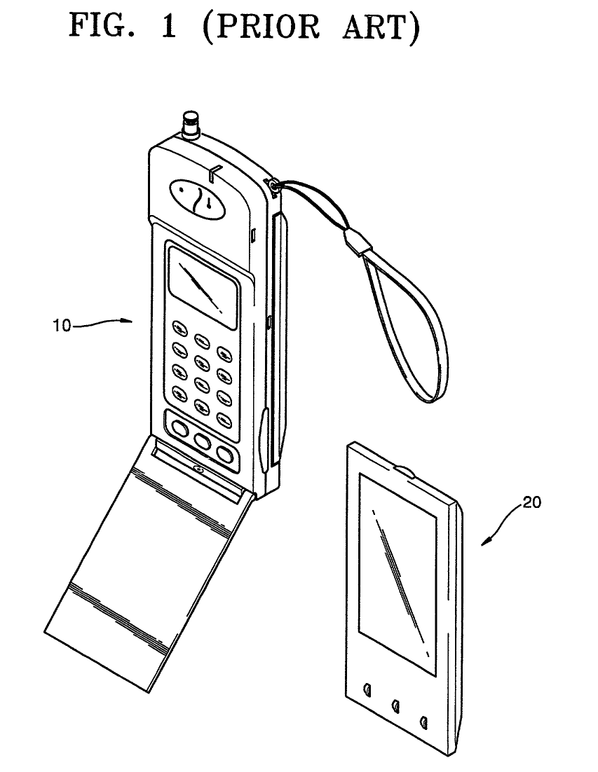

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described below in order to explain the present invention by referring to the figures.

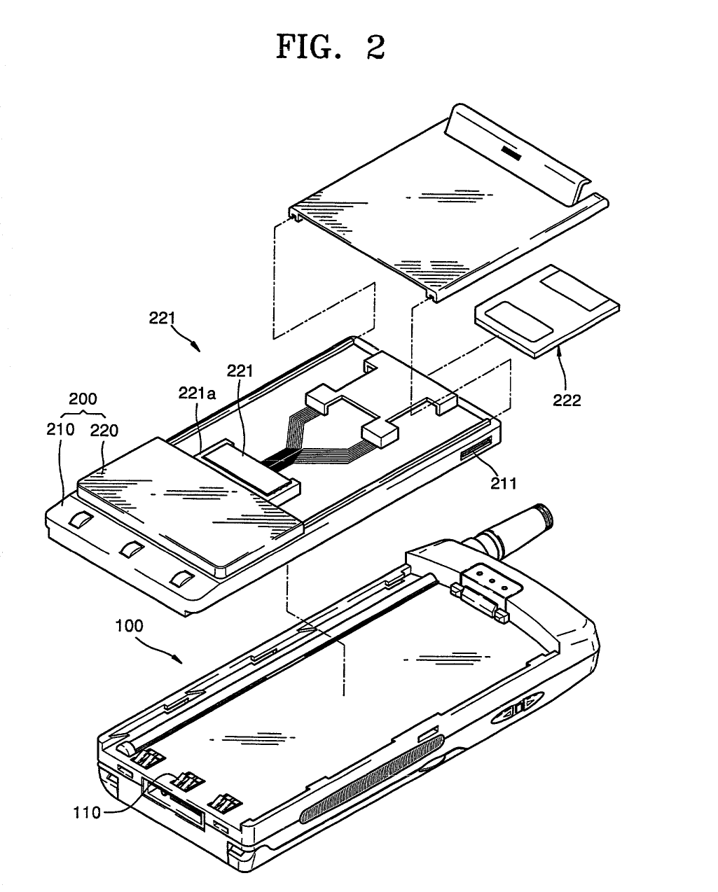

FIG. 2 shows a portable phone, which is an example of an electronic device, and a battery 200 for use in the electronic device according to an embodiment of the present invention. Referring to FIG. 2, the portable phone of the present invention includes a body 100 and the battery 200 that is detachable from the body 100. The body 100 includes a controller and a variety of main parts (not shown), which are supplied with current from the battery 200 in order to operate. However, it is understood that other electronic devices, such as personal digital assistants or portable computers, that use the battery 200 for primary or backup power can be used instead of the shown portable phone.

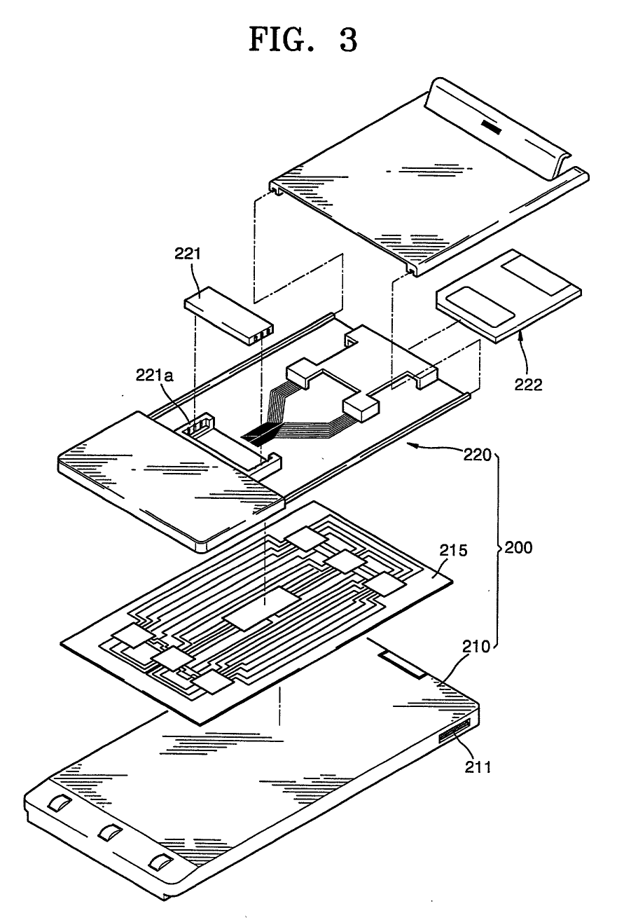

The battery 200, as shown in FIGS. 2 and 3, includes a battery unit 210 to supply current, a memory unit 220 having a disk drive 221 to store information, and a printed circuit board 215 to connect the battery unit 210 and the memory unit 220. In other words, the memory unit 220, which stores and interchanges information with the controller in the body 100, is installed on the battery 200. The memory unit 220 is supplied with current from the battery unit 210 of the battery 200 to operate. The battery 200 is combined with the body 100 to be connected to the controller of the body 100 using connecters 110 in the body 100 and the printed circuit board 215. Thus, the controller stores information, such as information which is downloaded through a connection to the Internet in the memory unit 220.

The memory unit 220 includes built-in a main memory 221, such as a semiconductor memory chip, and a detachable auxiliary memory 222, such as a memory card. The memory unit 220 has basic recording capacity due to the main memory 221, and a freely extendable recording capacity supplied by the auxiliary memory 222, which can be additionally installed as necessary. The memory unit 220 conveniently adjusts its recording capacity and freely transfers information using the detachable function of the auxiliary memory 222. As shown in FIG. 3, the built-in main memory 221 is detachable from a fixed block 221a in order to perform repair work or for the purpose of replacement. However, the memory 221 need not be detachable or could be made detachable for other reasons. Further, it is understood that the auxiliary memory 222 could be any recording medium, such as a magnetic or optical recording medium or a cartridge having the same.

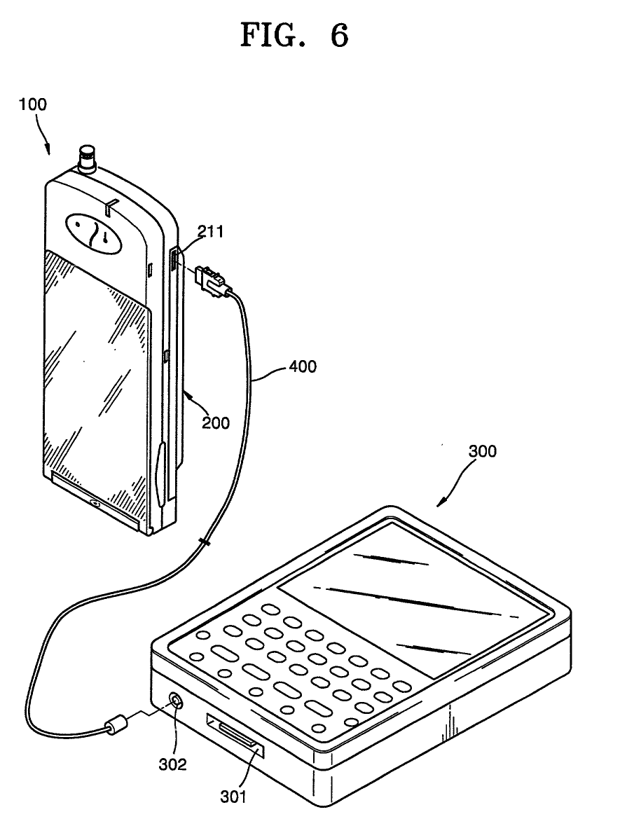

The battery 200 includes a power output port 211 and a communication port 223 as shown in FIGS. 2 through 4C. Using the power output port 211 and the communication port 223, the battery 200 can be selectively connected to other electronic devices as well as to the body 100 of the portable phone. The power output port 211 allows connection between the battery unit 210 and the another device, while the communication port 223 allows a connection between the memory unit 220 and the another electronic device. As shown in FIG. 6, an end of a power cable 400 plugs into the power output port 211 of the battery 200 and the other end of the power cable 400 is connected to a power input port 302 of another device 300, such as a portable phone or a personal digital assistant (PDA). The device 300 is thus supplied with power from the battery 200 to operate.

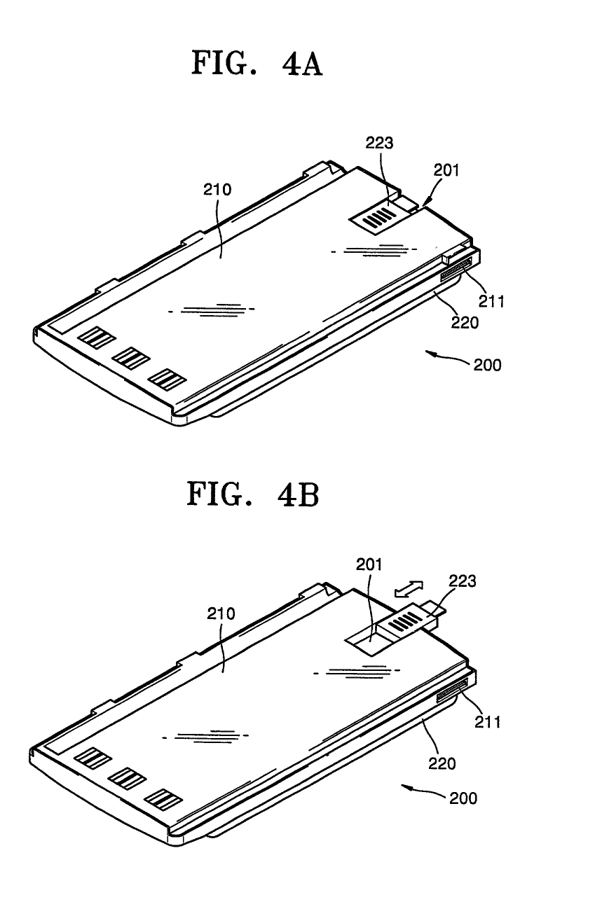

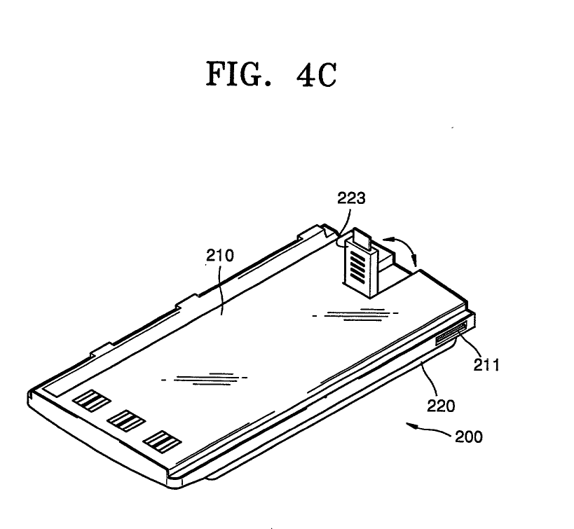

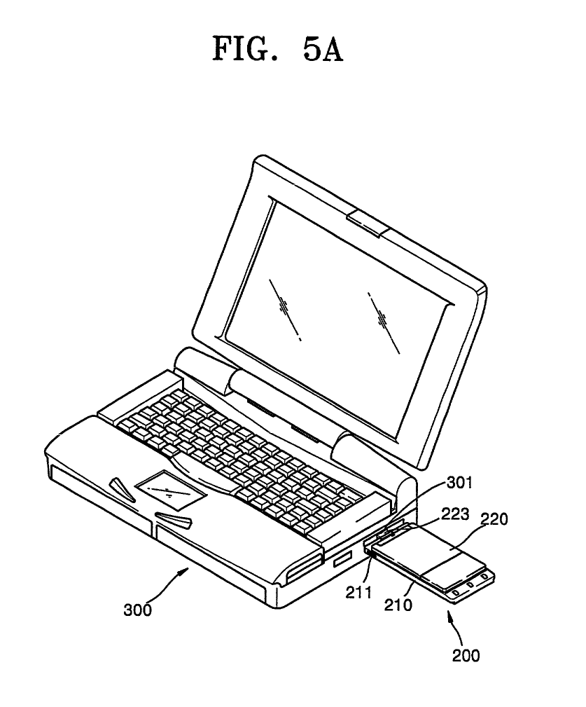

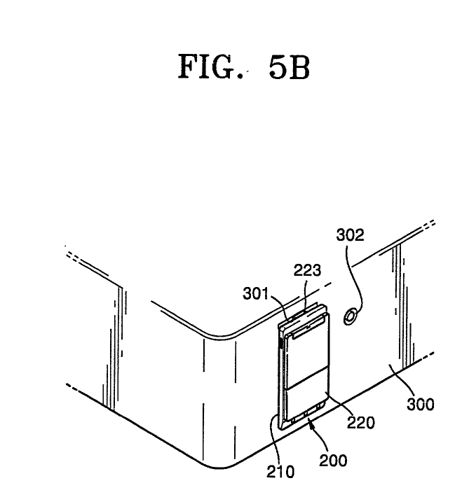

As shown in FIG. 4B, the communication port 223 is installed in a slide groove 201 of the battery unit 210 to slide and protrudes in order to be inserted into a USB port of a computer or a PDA as shown in FIG. 4B. Thus, when the memory unit 220 is connected to another device 300, such as a PDA, as shown in FIG. 5A, the communication port 223 protrudes and then is inserted into a USB port 301 of the another device 300 to allow information to be exchanged between the memory unit 220 and the device 300 according to an embodiment of the invention.

As shown in the embodiment in FIG. 4C, the communication port 223 pivots about one of its ends up to an angle of 900 with respect to the battery unit 210 of the battery 200. As shown in FIG. 5B, the battery unit 210 of the battery 200 may be closely coupled to the device 300 if the communication port 223 is pivoted to 900 in order to be connected in a narrow space. The communication port 223 is at all times internally connected to the memory unit 215 using the printed circuit board 215.

A use of a portable phone having the above-described configuration and using a battery is described below according to an embodiment of the invention. The portable phone according to an embodiment of the present invention provides a user with an opportunity to select whether the portable phone has an information storage function in addition to a communication function, or whether the portable phone has only the communication function. In other words, if user requires the portable phone to have the information storage function, the battery 200 having the memory unit 220 coupled to the body 100 to store information. If the user of the portable phone does not need the information storage function, the user will select a battery having only a general battery unit, such as a conventional battery 20, to be coupled to the body 100 instead of the battery 200. As such, it is simple to carry the portable phone and a user can select functions of a portable phone according to the present need.

In a case where the portable phone has the information storage function as shown in the embodiment in FIG. 2, the battery 200 is coupled to the body 100 such that the memory unit 220 is connected to the principal part such as controller built into the body 100 to store data. Thus, the controller of the body 100 stores information, such as information downloaded using the Internet in the memory unit 220. The controller also reads the information stored in the memory unit 220 and then transmit the read information using the Internet, or can display or indicate the information to the user using other mechanisms. Also, the user selects whether the memory unit 220 includes only the main memory 221, or whether the memory unit 220 includes the auxiliary memory 222 as well as the main memory 221 to extend capacity.

As shown in FIGS. 5A through 6, the memory unit 220 is connected to another device 330 to share information according to additional embodiments of the present invention. When another device 300 to be connected to the memory unit 220 is the same kind of portable phone as that to which the battery 200 belongs, the battery 200 is directly detached from the body 100 and then is coupled to the body 100 of the other portable phone without an additional connection cable or connection port. Thus, when the electronic devices are of the same kind, the battery unit 210 and the memory unit 220 of the battery 200 are connected to the body 100 of the other portable phone using the connecters 110 to supply power, allow access to stored data, and to store new data.

According to another embodiment of the invention, only the auxiliary memory 222 is detached from the body 100 and then is connected to the memory unit 220 of another portable phone to transfer information without detaching the entire battery 200 from the body 100.

However, when the battery 200 is connected to a different kind of device 300, such as a different kind of portable phone, a notebooks, or a PDA, as shown in FIGS. 5A through 6, the communication port 223 built into the battery 200 is inserted into the USB port 301 of another device 300. Then, the memory unit 220 is connected to the device 300 using the communication port 223 and the USB port 301 to interchange information with the device 300. Thus, information stored in the memory unit 220 may be transmitted to the device 300, and information stored in the another device 300 may be transmitted to the memory unit 220.

If the device 300 is supplied with power from the battery unit 220 of the battery 200, as shown in FIG. 6, the power output port 211 of the battery 200 is connected to the power input port 302 of the device 300 using the connection cable 400. Then, the device 300 is supplied with power from the battery 200 of the portable phone to operate.

In the electronic device of the present invention, the memory unit is installed on the battery 200, and thus the body of the electronic device having a controller is not complex and is connected to the Internet or another device anytime and anywhere to simply store required information. Also, a user can select whether a portable phone has an information storage function as well as a communication function, or has only a communication function in consideration of portable convenience.

As described above, if the electronic device according to the present invention is used, required information can be easily stored in a memory unit on a battery anytime anywhere. Also, the use of an information storage function can be easily selected only by replacement of a battery. Further, the battery having the memory unit could be used in non-portable electronic devices, such as scientific instruments, electronic vehicles, surveillance aircraft and satellites, and the like, where the replacement of the battery and/or the auxiliary memory would serve to provide additional energy to the device while allowing retrieval of the stored data from the old battery.

Although a few preferred embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An electronic apparatus comprising:
an electronic device including a body; and
a battery coupled to the body to supply current to said electronic device,
wherein said battery includes a memory unit having a built-in main memory and a detachable auxiliary memory.

2. The electronic apparatus of claim 1, wherein said battery further comprises a primary power connection to connect to said electronic device, and a secondary power output port to connect to another device to supply current thereto.

3. The electronic apparatus of claim 1, wherein said battery further comprises a primary communication connection to connect to said electronic device, and a communication port to connect the memory unit to another device to exchange information with the another device.

4. The electronic apparatus of claim 3, wherein the secondary communication port is installed to slide so that a free end of the secondary communication port protrudes from said battery to connect to the another device.

5. The electronic apparatus of claim 3, wherein the secondary communication port is disposed to be flipped out from a body of said battery at a predetermined angle.

6. The electronic apparatus of claim 1, wherein the main memory is detachable from the memory unit.

7. The electronic apparatus of claim 1, wherein the main memory is one of a memory chip and a memory card, and the auxiliary memory is the other of the memory chip and the memory card.

8. A battery for an electronic device, comprising:
a battery unit to store power; and
a memory unit connected to said battery unit, said memory unit comprising
a built-in main memory, and
an auxiliary memory that is detachable from said battery unit,
wherein the battery is detachable from the electronic device.

9. The battery of claim 8, further comprising a primary power connection to connect to the electronic device and a secondary power output port to connect to another device to supply current thereto.

10. The battery of claim 8, further comprising a primary communication connection to exchange information with the electronic device, and a secondary communication port to connect said memory unit to another device to exchange information with the another device.

11. The battery of claim 10, wherein said secondary communication port is installed to slide so that a free end of said secondary communication port protrudes from the battery to connect to the another device.

12. The battery of claim 10, wherein said secondary communication port is disposed to be flipped out from a body of the battery at a predetermined angle.

13. The battery of claim 8, wherein the main memory is detachable from said memory unit.

14. The battery of claim 8, wherein the main memory is one of a memory chip and a memory card, and the auxiliary memory is the other of the memory chip and the memory card.

15. An electronic apparatus comprising:
an electronic device; and
a battery coupled to said electronic device, said battery comprising
an energy storage unit to power said electronic device, and
a memory comprising memory units accessible by said electronic device.

16. The electronic apparatus of claim 15, wherein one of the memory units is detachable from said battery.

17. The electronic apparatus of claim 15, wherein one of the memory units is detachable from the memory.

18. The electronic apparatus of claim 16, wherein said electronic device is one of a portable phone, a personal digital assistant, and a computer.

19. The electronic apparatus of claim 16, wherein said battery includes a communication port through which another electronic device accesses the memory.

20. The electronic apparatus of claim 16, wherein said battery includes a connector through which another electronic device is powered by said battery.

21. The electronic apparatus of claim 19, wherein said battery includes a connector through which another electronic device is powered by said battery, wherein said battery is attached to said electronic device when the another electronic device is connected to one of the connector and the communication port.

22. A battery for use with an electronic device and/or electronic devices, comprising:
an energy storage unit to power the electronic device; and
a memory connected to said energy storage unit and comprising memory units accessible by the electronic device.

23. The battery of claim 22, wherein one of the memory units is detachable from the battery.

24. The battery of claim 22, wherein one of the memory units is detachable from said memory.

25. The battery of claim 24, further comprising communication ports through which the electronic devices are detachably connected to accesses said memory.

26. The battery of claim 24, further comprising connectors through which the electronic devices are detachably connected to be powered by said energy storage unit.

27. The battery of claim 25, further comprising connectors through which the electronic devices are detachably connected to be powered by said energy storage unit, wherein the battery is simultaneously attachable to multiple electronic devices.

28. The battery of claim 27, further comprising a printed circuit board to connect said memory to said communication ports.

29. The battery of claim 27, wherein the one memory unit comprises a recordable medium housed in a case.

30. The battery of claim 27, wherein the one memory unit comprises a memory card, and another one of the memory units comprises a memory chip.

31. A method of storing information and power for use with an electronic apparatus, comprising:
connecting the electronic apparatus to a battery comprising a battery unit to store energy and memory units to store information to be accessed by the electronic apparatus; and
forming a communication pathway to transfer information between the electronic device and one of the memory units.

32. The method of claim 31, forming an energy pathway to supply the energy stored in the battery unit to the electronic apparatus while the communication pathway is formed.

33. The method of claim 31, further comprising;
connecting another electronic apparatus to the battery; and
forming another communication pathway between the another electronic apparatus and the one memory unit to transfer information between the one memory unit and the another electronic apparatus.

34. The method of claim 33, wherein both the electronic apparatus and the another electronic apparatus are connected to the battery at the same time.

35. The method of claim 33, wherein both the electronic apparatus and the another electronic apparatus are not connected to the battery at the same time.

36. The method of claim 35, further comprising detaching the battery from the electronic apparatus prior to said connecting the another electronic apparatus to the battery.

37. The method of claim 36, wherein the electronic apparatus and the another electronic apparatus are of the same kind.

38. The method of claim 31, further comprising:
detaching the battery from the electronic apparatus; and
connecting the electronic apparatus to another battery.

39. The method of claim 38, wherein the another battery includes another memory unit.

40. The method of claim 38, wherein the another battery does not include another memory unit.

41. The method of claim 31, further comprising forming another communication pathway such that a detachable one of the memory units is accessible by the electronic apparatus.

42. The method of claim 41, further comprising attaching the detachable memory unit to the battery prior to said forming the another communication pathway.

43. The method of claim 42, further comprising detaching the detachable memory unit from another electronic apparatus prior to said attaching the detachable memory unit to the battery.
